(19) United States
(12) Patent Application Publication
(10) Pub. No.: US 2010/0013802 A1
(43) Pub. Date: Jan. 21, 2010

(54) DRIVER AND METHOD FOR DRIVING ELECTRO-OPTICAL DEVICE, ELECTRO-OPTICAL DEVICE, AND ELECTRONIC APPARATUS

(75) Inventors: Hiroyuki HOSAKA, Matsumoto-shi (JP); Taku KITAGAWA, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/466,030

(22) Filed: May 14, 2009

(30) Foreign Application Priority Data
Jul. 16, 2008 (JP) 2008-185099

(51) Int. Cl. G09G 5/00

(52) U.S. Cl. 345/204

(57) ABSTRACT

A driver subfield-drives an electro-optical device that includes a plurality of scanning lines, a plurality of data lines and a plurality of pixels, one of the plurality of pixels corresponding intersection point where one of the plurality of scanning lines and one of the plurality of data lines intersect each other. The driver includes a scan signal supplying unit that supplies the one of the scanning line with a scan signal to select the one of the scanning line, and a video signal supplying unit that supplies the one of the data line with a plurality of video data signals which includes a first video data signal and a second video data signal. An i-th selection period in which the one of the scanning line is selected is divided into a plurality of subfields which includes a first subfield and a second subfield. The first video data signal is supplied in the first subfield, and the second video data signal is supplied in the second subfield.

### BACKGROUND

1. Technical Field

The present invention relates to a driver and method for driving an electro-optical device, such as a liquid-crystal device that displays gray scale through subfield-driving method, and to an electro-optical device including such a driver, and an electronic apparatus, such as a liquid-crystal projector.

2. Related Art

The driver divides one field into a plurality of subfields, and supplies each pixel in each subfield with one of an on voltage and an off voltage to display a gray scale of an image. In other words, the driver performs subfield-driving. For example, JP A-2003-114661 discloses a technique to display gray scale. In accordance with the disclosed technique, the duration of a subfield is set to be shorter than a saturation response time that is needed to saturate a change in a transmittance of an electro-optical material when the on voltage is applied. Whether the on voltage is applied in a particular subfield is determined based on display data.

However, in the subfield-driving method, the number of subfields forming one field needs to be increased in order to increase the number of gray scales. In comparison with a driving method in which the subfield-driving method is not used, a scanning rate or a driving frequency needs to be greatly increased. The driver, wiring, switching elements are difficult to design in view of high driving frequency.

### SUMMARY

An advantage of some aspects of the invention is that a driver and a method for driving an electro-optical device improves reproducibility of gray scale by performing subfield-driving method without increasing the scanning speed. Another advantage of some aspects of the invention is that an electro-optical device including the driver, and an electronic apparatus including the electro-optical device are provided.

In accordance with one aspect of the invention, a first driver drives an electro-optical device using the subfield-driving method, which includes a plurality of scanning lines, a plurality of data lines and a plurality of pixels. One of the plurality of pixels corresponds intersection where one of the plurality of scanning lines and one of the plurality of data lines intersect each other. The first driver includes a scan signal supplying unit that supplies the one of the scanning line with a scan signal to select the one of the scanning line, and a video signal supplying unit that supplies the one of the data line with a plurality of video data signals which includes a first video data signal and a second video data signal. An i-th selection period in which the one of the scanning line is selected is divided into a plurality of subfields which includes a first subfield and a second subfield. The first video data signal is supplied in the first subfield, and the second video data signal is supplied in the second subfield.

When a variety of signals including a power signal, a data signal, a control signal are input to or output from the first driver, the scan signal supplying unit containing a scanning line driving circuit and the like incorporated in a board supplies the scan signal to pixel via the plurality of scanning lines on a line-at-a-time basis. In parallel with this operation, the video signal supplying unit containing a data line driving circuit, a sampling circuit, etc., incorporated in the board supplies the video data signal to the pixel via the plurality of data lines concurrently or successively. The “pixel” are arranged in a matrix on the image display region, and are produced by sandwiching an electro-optical material such as a liquid crystal between a pair of substrates. The pixel is active matrix addressed by a thin-film transistor (TFT). For example, when the scan signal is applied to a gate terminal of the TFT, the video data signal supplied form the data line is written through the source-drain of the TFT onto a pixel electrode forming the pixel. As a result, a drive voltage corresponds to the video data signal is written between a pixel electrode and an opposed electrode, forming the pixel, thereby changing an operational state of the electro-optical material, such as an alignment state of a liquid crystal.

The “video signal supplying unit” supplies the one of the data line with the first video data signal and the second video data signal in the first subfield and in the second subfield, respectively. More specifically, while one scanning line is selected, the video data signal which is supplied to a pixel connected to the scanning line is changed. The “i-th selection period” means a period throughout which the scan signal is supplied to the particular i-th scanning line of the plurality of scanning lines, i.e., one horizontal scanning period. The “video data signal” typically refers to one of a digital on voltage signal and a digital off voltage signal used in the subfield-driving method. When the video data signal is applied to each pixel, digital driving, i.e., the subfield-driving method is performed.

The first video data signal and the second video data signal are written to a pixel during the i-th selection period, and the voltage applied to a pixel which is connected to the i-th selection period is thus switched between the on voltage and the off voltage within the i-th selection period. The pixel is thus driven by the subfield-driving method on a line-at-a-time scanning basis. One selection period corresponds to a plurality of subfields rather than a single subfield, or one selection period is divided into a plurality of subfields. In other words, The first video data signal and the second video data signal are written to a pixel during the i-th selection period so that the polarity of the voltage applied to the pixel is switched during the i-th selection period. This operation, if repeated on all the scanning lines, is substantially equivalent to an driving operation that is performed with one frame divided into a plurality of subfields. The number of subfields is thus increased without increasing the driving speed of the scanning lines. An electro-optical operation such as display operation is thus performed based on the subfield-driving method.

The scan signal is typically kept at a high level during the i-th selection period. As long as the same scanning line is continuously selected (i.e., there is no change in the selected scanning line to which the scan signal is supplied), whether the scan signal remains unchanged or is changed between a high level and a low level is not important. For example, the scan signal is changed from a high level to a low level and then changed back to the high level again.

Without increasing the scanning speed of the scanning lines, the first driver can thus increase the number of subfields in accordance with timings of writing the video data signals. As a result, a display device which is driven on a line-at-a-time scanning basis can display a high-quality image using the subfield-driving method featuring a large number of gray scales.

The video signal supplying unit may supply, as the video data signal, one of an on voltage and an off voltage responsive to a gray scale to be displayed for each of the plurality of pixels in each of the plurality of subfields.

With this arrangement, a binary data signal of the on voltage and/or the off voltage responsive to the gray scale of each pixel is applied in each subfield. The digital driving (subfield-driving method) is thus performed. The pixel is supplied with the on voltage or the off voltage in each subfield, and is thus not supplied with a video data signal at an intermediate voltage level between the on voltage and the off voltage. A plurality of gray scales is displayed based on a time average of a display of a particular pixel displayed by applying the on voltage (i.e., white or black) and a display of the particular pixel displayed by applying the off voltage (i.e., black or white). For example, if one frame is divided into M subfields, the number of gray scales feasible is M+1.

A code pattern may be stored on a storage unit such as a memory to identify each subfield at which the on voltage and/or the off voltage is to be supplied in response to the video signal. In accordance with the code pattern, the subfield at which the on voltage and/or the off voltage is supplied is thus determined.

In accordance with another aspect of the invention, the video signal supplying unit may supply the video data signal by a plurality of times within the i-th selection period in at least two subfields of the plurality of subfields, and the video signal supplying unit may supply the video data signal once within the i-th selection period in the remaining subfields of the plurality of subfields excluding the at least two subfields.

Since the video signal supplying unit supplies the video data signal by a plurality of times within the i-th selection period in at least two subfields of the plurality of subfields, a particular subfield may be divided into even finer subfields in response to supplying timings of the video data signal. The number of subfields is thus increased, and the gray scale presentation is enhanced. It is noted that a subfield not supplied with the video data signal by a plurality of times may be included.

In accordance with another aspect of the invention, the video signal supplying unit may supply the plurality of video data signals consecutively within the i-th selection period in a serial manner.

With this arrangement, the number of subfields is easily increased by simply increasing the number of video data signals consecutively supplied during the i-th selection period. Since no extra signals are present between the supplied video data signals, the period of the subfield is substantially shortened. As a result, the number of subfields in one field is greatly increased. A driver for a high-quality display device thus can be realized.

In accordance with another aspect of the invention, the video signal supplying unit may supply the plurality of video data signals nonconsecutively within the i-th selection period in a serial manner.

With this arrangement, the video signal supplying unit adjusts a timing of supplying the video data signal so that any waiting time is set between two video data signals adjacent in time to each other of a plurality of video data signals supplied to the pixels. With such a waiting time, a duration of each subfield can be adjusted. The number of gray scales displayable with respect to the number of subfields is thus increased.

In accordance with another aspect of the invention, the video signal supplying unit may supply the plurality of video data signals at regular intervals within the i-th selection period.

With this arrangement, the plurality of video data signals is supplied every time duration into which one horizontal period is equally divided. In a relatively simple control operation, the subfield having a particular duration is efficiently arranged within one horizontal period.

In accordance with another aspect of the invention, the video signal supplying unit may supply the plurality of video data signals at irregular or arbitrary intervals within the i-th selection period.

With this arrangement, the video signal supplying unit can adjust the timing of the supplying of the video data signal. More specifically, one horizontal period can be divided into subfields having various durations, and the number of displayable gray scales is thus increased with respect to the number of subfields.

In accordance with another aspect of the invention, the plurality of scanning lines is divided into a plurality of groups which comprises a first group and a second group. The one of the plurality of scanning lines is selected from the first group and the second group alternately, and the video signal supplying unit supplies the one of the plurality of date lines with the plurality of video data signals in synchronization with the scan signal.

With this arrangement, the scanning lines on a plurality of areas vertically spaced from each other within the image display region are alternately driven on a line-at-a-time scanning basis. The video data signal is then supplied to the data line in synchronization with the scan signal driving the scanning line. The plurality of areas are thus scanned (area scanning method).

The scan signal supplying unit may supply the scan signal to the same scanning line of the plurality of scanning lines before and after alternating from which group the one of the plurality of scanning lines is selected.

With this arrangement, the scan signal used to drive the scanning lines on a plurality of areas vertically spaced from each other within the image display region is supplied to the same scanning line before and after alternating from which group the one of the plurality of scanning lines is selected. More specifically, the single scanning line is selected by a plurality of scan signals supplied at different times. By shifting on a line-at-a-time basis the scanning line thus selected, the number of gray scales obtained by subfield-driving method with area scanning method is increased.

In accordance with another aspect of the invention, a second driver drives an electro-optical device using subfield-driving method. The electro-optical device includes a plurality of scanning lines, a plurality of data lines and a plurality of pixels. One of the plurality of pixels corresponds intersection point where one of the plurality of scanning lines and one of the plurality of data lines intersect each other. The driver comprises a scan signal supplying unit that supplies the one of the scanning line with a scan signal to select the one of the scanning line, and a video signal supplying unit that supplies the one of the data line with a plurality of video data signals in synchronization with the scan signal. The plurality of video data signals includes a first video data signal and a second video data signal. A frame period is divided into a plurality of subfields which includes a first subfield and a second subfield, and the first video data signal is supplied in the first subfield, and the second video data signal is supplied in the second subfield. The plurality of scanning lines is further divided into a plurality of groups which comprises a first group and a second group, and the one of the plurality of scanning lines is selected from the first group and the second group alternately. The scan signal supplying unit supplies the scan signal to the same scanning line of the plurality of scanning lines before and after alternating which group the one of the plurality of scanning lines is selected from.

During operation, the scan signal supplying unit supplies the scan signal to the pixel via one of the plurality of scanning lines on a line-at-a-time scanning basis. In parallel with this operation, the video signal supplying unit supplies the video data signal to the pixel via one of the plurality of data lines concurrently or successively.

On a line-at-a-time scanning basis, the scan signal supplying unit supplies, via the plurality of scanning lines, the scan signal alternately to the plurality of areas, into which the plurality of the scanning lines is divided. The scan signal supplying unit supplies the scan signal via the same scanning line of the plurality of scanning lines before and after alternating which group the one of the plurality of scanning lines is selected from. A scanning operation is thus performed on the plurality of areas at a time (area scanning method). Since the scan signal is supplied via the same scanning line before and after alternating which group the one of the plurality of scanning lines is selected from, the number of gray scales is increased in the subfield-driving method with the area scanning method.

One of the areas vertically spaced from each other within the image display region is supplied with the scan signal via the same scanning line before and after alternating which group the one of the plurality of scanning lines is selected from, and the other of the areas is supplied with the scan signal consecutively twice via the same scanning line. More specifically, the scanning line in the one area is supplied with the scan signal once when the scanning turn of the area comes. When the next scanning turn of the area comes, the scan signal is supplied once via the same scanning line. When the scanning turn of the other area comes, the same scanning line in the other area is supplied with the scan signal twice consecutively.

The second driver increases the number of subfields in accordance with the timing of writing the video data signal without increasing the scanning speed of the scan lines in the area scanning. As a result, a display device operating on a line-at-a-time scanning basis in which an image is displayed by driving successively the plurality of scanning lines, can display a high-quality image by the subfield-driving method featuring a large number of gray scales.

In accordance with another aspect of the invention, the video signal supplying unit may supply the video data signal at regular intervals before and after alternating which group the one of the plurality of scanning lines is selected from.

With this arrangement, the subfields are equal to each other in time duration, and the plurality of subfields can be efficiently placed within one frame.

The second driver may have the same operation and structure as those of the first driver.

In accordance with another aspect of the invention, a first driving method is related to a driving method which drives an electro-optical device using subfield-driving method. The electro-optical device includes a plurality of scanning lines, a plurality of data lines and a plurality of pixels. One of the plurality of pixels corresponds intersection where one of the plurality of scanning lines and one of the plurality of data lines intersect each other. The first driving method includes supplying the one of the scanning line with a scan signal to select the one of the scanning line, and supplying the one of the data line with a plurality of video data signals which includes a first video data signal and a second video data signal. An i-th selection period in which the one of the scanning line is selected is divided into a plurality of subfields which includes a first subfield and a second subfield, and the first video data signal is supplied in the first subfield, and the second video data signal is supplied in the second subfield.

As the first driver, the first driving method reliably drives the electro-optical device in response to a change in response characteristics of the pixel.

The first driving method has the same operation that is performed by the first driver.

In accordance with another aspect of the invention, an electro-optical device includes one of the first driver and the second driver.

The electro-optical device, including one of the first driver and the second driver, displays a high-quality image regardless of a change in the response characteristics of the pixel.

In accordance with another aspect of the invention, an electronic apparatus includes the electro-optical device.

The electronic apparatus including the liquid-crystal device displays a high-quality image. The electronic apparatus thus finds applications as a variety of electronic apparatuses including a projection-type display apparatus, a cell phone, an electronic notebook, a wordprocessor, a viewfinder type video cassette recorder, a direct-monitor type video cassette recorder, a workstation, a video phone, a point of service (POS) terminal, and a touchpanel. An electrophoresis device such as electronic paper may be embodied as the electro-optic device of embodiments of the invention.

These and other operations and advantages will be apparent from the following description of the exemplary embodiments.

### BRIEF DESCRIPTION OF THE DRAWINGS

The invention will be described with reference to the accompanying drawings, wherein like numbers reference like elements.

FIG. 1 is a block diagram illustrating a general structure of a driver of an electro-optical device in accordance with a first embodiment of the invention.

FIG. 2 is a timing diagram of start pulses in accordance with the first embodiment of the invention.

FIG. 3 is a timing diagram of control signals in accordance with the first embodiment of the invention.

FIG. 4 illustrates an arrangement of scanning lines in the driver of the electro-optical device in accordance with the first embodiment of the invention.

FIG. 5 is a timing diagram of control signals in accordance with a second embodiment of the invention.

FIG. 6 is a block diagram of a general structure of the driver in an electro-optical device in accordance with a third embodiment of the invention.

FIG. 7 diagrammatically illustrates a scanning line driving circuit in accordance with the third embodiment of the invention.

FIG. 8 is a timing diagram illustrating control signals of the scanning line driving circuit in accordance with the third embodiment of the present invention.

FIG. 9 is a timing diagram of control signals in accordance with the third embodiment of the present invention.

FIG. 10 is a plan view of the electro-optical device in accordance with one embodiment of the invention.

FIG. 11 is a sectional view of the electro-optical device taken along line VI-VI in FIG. 10.

FIGS. 12A and 12B illustrate examples of the electronic apparatus in accordance with one embodiment of the invention.

FIG. 13 illustrates an example of the electronic apparatus in accordance with another embodiment of the invention.

### DESCRIPTION OF EXEMPLARY EMBODIMENTS

The preferred embodiments of the invention are described below with reference to the drawings.

### First Embodiment

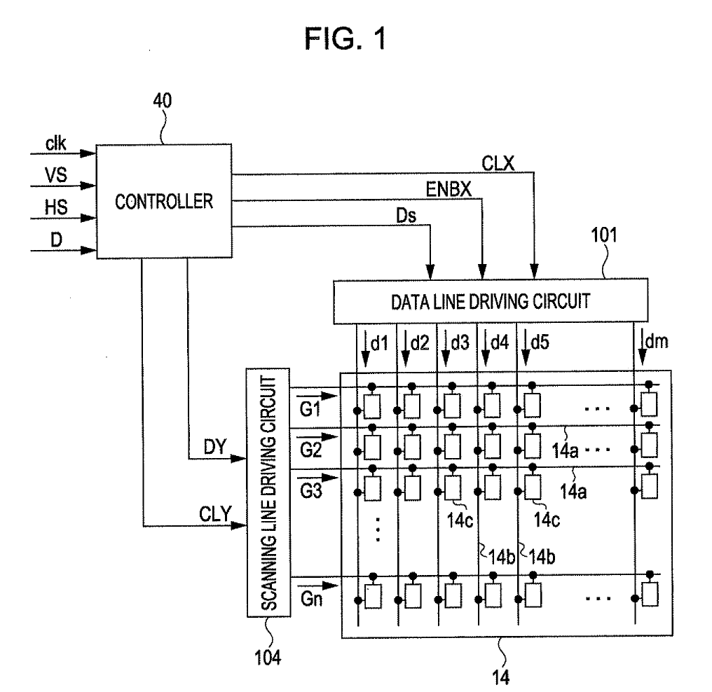

A driver in an electro-optical device of a first embodiment of the invention is described below with reference to FIG. 1. FIG. 1 is a block diagram of a general structure of an image display device in accordance with the first embodiment of the invention.

Referring to FIG. 1, the image display device includes as main elements thereof a controller 40, a scanning line driving circuit 104, a data line driving circuit 101, and a display panel 14. The image display device acquires a video signal and then displays an image responsive to the video signal. More specifically, the image display device display the image in accordance with a subfield-driving method. In the subfield-driving method, one field is divided into a plurality of subfields, and one of an on voltage, which is applied to a pixel to display one of a bright state and a dark state, and an off voltage, which is applied to a pixel to display the other of a bright state and a dark state, is applied to each pixel in each field. More specifically, within one subfield period, one of binary voltages, i.e., one of the on voltage and off voltage is written on a pixel, and this operation is repeated on all the subfields which forms one field. Brightness of each pixel is thus determined in one field period. A converter circuit and the like contained in the controller 40 generates as a video data signal a digital signal representing one of the on voltage and the off voltage responsive to a gray scale to be displayed by each pixel. The video data signal is thus supplied by the controller 40.

The controller 40 acquires a clock signal clk, a vertical scanning signal VS, a horizontal scanning signal HS, and a video signal D from the outside. In response to these acquired signals, the controller 40 generates a start pulse DY, a scanning side transfer clock CLY, a data transfer clock CLX, an enable signal ENBX, and a video data signal Ds. The start pulse DY is a pulse signal to be output at the start timing of scanning in the scanning side (Y side). The scanning side transfer clock CLY defines a horizontal scanning of the scanning side (Y side). The enable signal ENBX is a pulse signal that determines the timing at which the data transfer to the scanning line driving circuit 104 starts and at which scanning line basis data is output to each pixel 14c. The enable signal ENBX is output in synchronization with a level transition (at a rising edge or a falling edge) of the scanning side transfer clock CLY. The data transfer clock CLX is a signal that defines the timing of the transfer of data to the data line driving circuit 101. The video data signal Ds is a voltage signal corresponds to the video signal D, and indicates a high level or a low level to set the pixel 14c to an on state or an off state at each subfield. The on state corresponds to one of the bright state and the dark state, and the off state corresponds to the other of the bright state and the dark state.

Upon receiving the start pulse DY and the scanning side transfer clock CLY from the controller 40, the scanning line driving circuit 104 successively outputs scan signals G1, G2, G3, . . . , Gn to the scanning lines 14a of the display panel 14. More specifically, the scanning line driving circuit 104, including a shift register, successively drives the scanning lines 14a in accordance with the scanning side transfer clock CLY in response to the start pulse DY supplied from the controller 40, i.e., drives the scanning lines 14a on a line-at-a-time basis. In the first embodiment of the invention, the scanning lines 14a are selected on a line-at-a-time scanning basis. Alternatively, the scanning lines 14a may be selected in another method.

Upon receiving the enable signal ENBX, the data transfer clock CLX, and the video data signal Ds from the controller 40, the data line driving circuit 101 outputs data signals d1, d2, d3, . . . , dm to data lines 14b of the display panel 14. More specifically, the data line driving circuit 101 successively latches m video data signals Ds corresponding to the number of data lines 14b within one horizontal scanning period, and then supplies the m latched video data signals Ds as data signals d1, d2, d3, . . . , dm respectively to the data lines 14b at a time. The enable signal ENBX is set to be at a high level during operation of the driver in accordance with the first embodiment, and the pixel 14c is supplied with a drive voltage responsive to the output value of the video data signal Ds.

The display panel 14, including a liquid crystal display (LCD), displays an image in response to voltage application. The display panel 14 includes scanning lines 14a, data lines 14b, and pixels 14c. More specifically, the display panel 14 includes n scanning lines 14a (n being an even number) extending in an X direction (row direction), and m data lines 14b extending in a Y direction (column direction). The pixels 14c are arranged in a matrix of intersections of the scanning lines 14a and the data lines 14b.

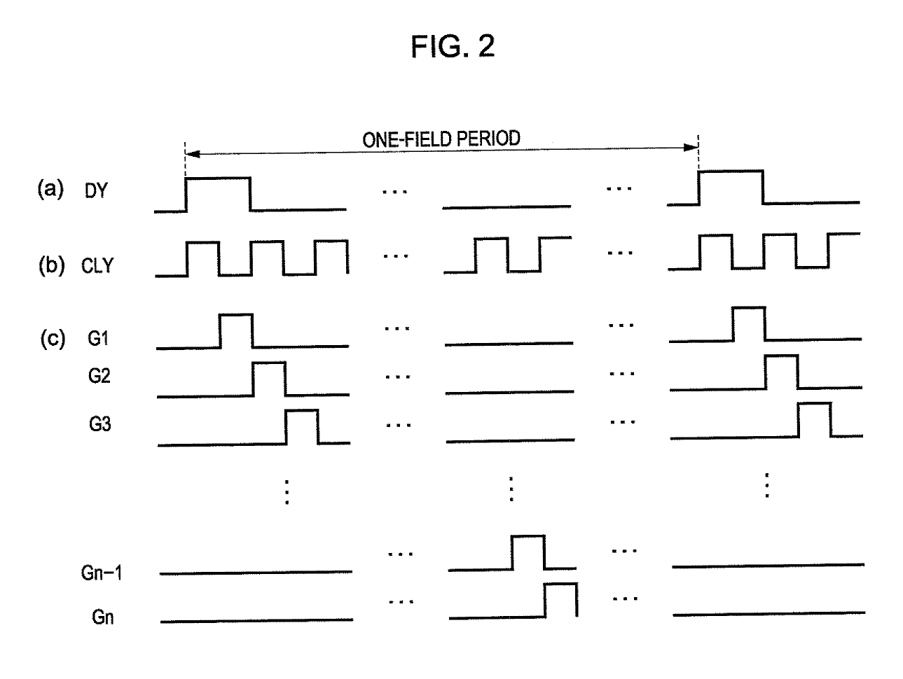

Control signals used in operation of the driver are described below with reference to FIG. 2. FIG. 2 is a timing diagram of the Y start pulse DY, the scanning side transfer clock CLY, and a scan signal On output from the scanning line driving circuit 104.

Upon receiving the vertical scanning signal VS, the controller 40 generates the Y start pulse DY every vertical scan period (one field period). The controller 40 thereafter generates the scan signals G1-Gn in accordance with the scanning side transfer clock CLY. More specifically, the scanning line driving circuit 104 including the shift register successively outputs the scan signal Gn at a timing synchronized with the scanning side transfer clock CLY. When one field period has elapsed, the start pulse DY is input again, and the scan signal On is again successively output.

As will be described later, a plurality of video data signals Ds need to be written onto the pixels while the scanning line to which the pixels are connected is selected by the scan signal Gn. The scanning side transfer clock CLY is set to be lower in frequency than in typical driving method.

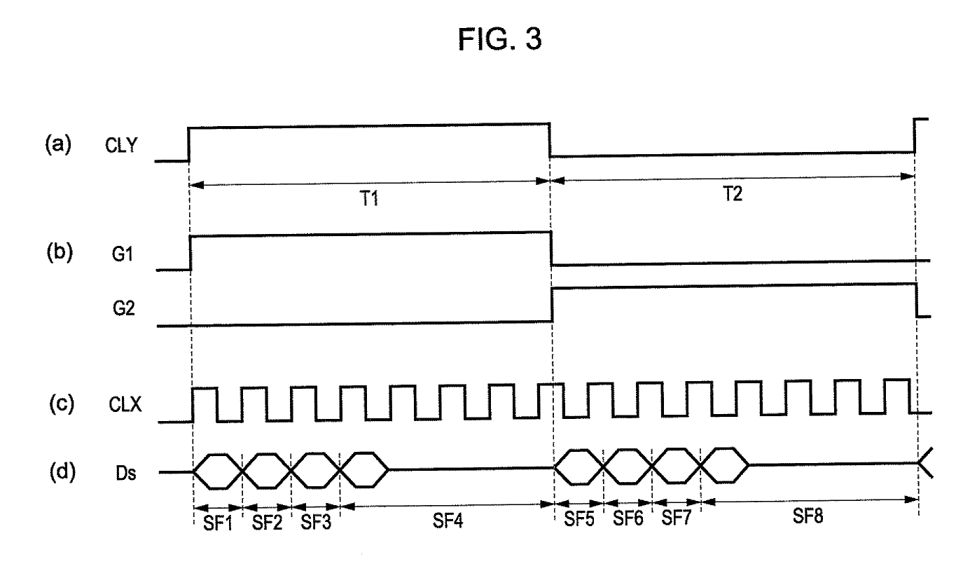

The timings of the particular scan signal Gn and the video data signal Ds are described with reference to the timing diagram illustrated in FIG. 3. FIG. 3 illustrates the scanning side transfer clock CLY, the scan signal Gn (FIG. 3 illustrates representatively G1 and G2 only), the data transfer clock CLX, and the video data signal Ds. Let period T1 represent a first half period of the scanning side transfer clock CLY and let period T2 represent a second half period of the scanning side transfer clock CLY. Here, period Ti corresponds to the “i-th selection period.” More specifically, the period T1 is a first selection period and the period T2 is a second selection period as illustrated in FIG. 3. In accordance with the first embodiment of the invention, the scan signal remains high in each selection period. Alternatively, the scan signal may be changed from high to low, and then changed back to high again in each selection period. Such a scan signal may be supplied to the same scanning line.

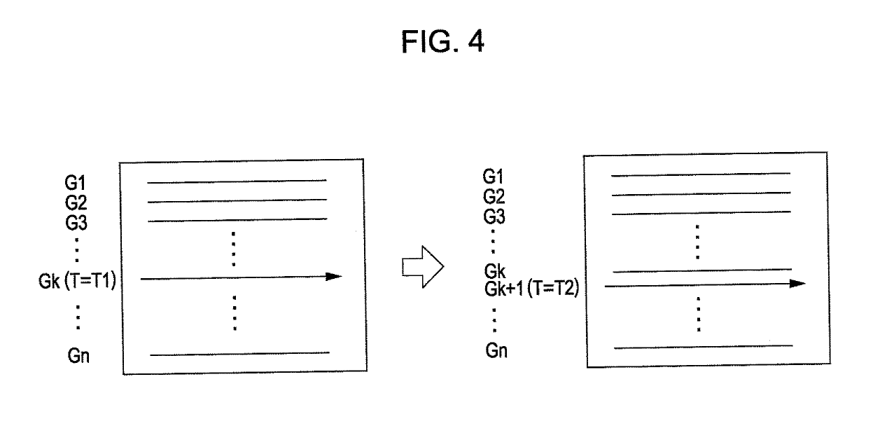

During the period T1, the scan signal G1 remains at a high level, and the scan signal G2 remains at a low level. During the period T2, the scan signal G2 remains at a high level and the scan signal G3 remains at a low level. The scan signal is successively shifted every half period of the scanning side transfer clock CLY (see FIG. 2). As illustrated in FIG. 4, a scanning line Gk is selected during the period T1, and a scanning line Gk+1 immediately below the scanning line Sk is selected during the period T2. The scan signal Gn output from the scanning line driving circuit 104 is successively shifted every half period of the scanning side transfer clock CLY in the display panel 14 of the driver.

Returning to FIG. 3, the data line is supplied with the video data signal Ds in synchronization with the data transfer clock CLX during the period T1. More specifically, a digital signal representing one of the on voltage and the off voltage is input and written on the pixel 14c which is selected by the scan signal Gn.

As represented in a portion (d) of FIG. 3, four video data signals Ds are written during the period T1 while the scanning line is selected by the scan signal G1. During the period T2, a scanning line immediately below the scanning line selected by the scan signal G1 is selected in the image display region by the scan signal G2 and four video data signals Ds are written. In a portion (c) of FIG. 3, data is written four times in each case. Alternatively, the video data signal Ds can be written by any number of times as long as the period T1 is not exceeded.

Data is written by a plural number of times while a single scanning line is selected so that one horizontal period (i.e., one of the period T1 or the period T2) is divided into four subfields. In other words, the duration of the subfield obtained by dividing one horizontal period is defined by the writing timing of the video data signal Ds. After the fourth data is written, the data writing is not performed until the period T1 ends. Subfield SF4 is thus longer in time than each of subfields SF1-SF3. During the period T2, subfield SF3 is longer in time than each of subfields SF5-SF7.

The video data signal Ds representing one of the one voltage and the off voltage is supplied in each subfield. The pixels are thus driven by subfield-driving method, and a display corresponds to the on voltage (i.e., white or black) and a display corresponds to the off voltage (i.e., black or white) are displayed. A video data signal at an intermediate level between the on voltage and the off voltage is not supplied. A plurality of gray scales are displayed in each pixel based on the time average of the display corresponds to the on voltage and the display corresponds to the off voltage.

The plurality of the video data signals is written within the i-th selection period so that the i-th selection period is divided into a plurality of finer subfields. The subfield-driving method is thus performed. The number of subfields is increased in response to the number of writing of the plurality of the video data signals without increasing the scanning speed of the scanning lines. As a result, a display device operating on a line-at-a-time scanning basis in which an image is displayed by driving successively the plurality of scanning lines, can display a high-quality image using the subfield-driving method featuring a large number of gray scales.

In accordance with the first embodiment of the invention, The plurality of the video data signals is supplied consecutively in each of the period T1 and the period T2. With the video data signal Ds supplied in this way, the number of subfields is easily increased by simply increasing the number of supplied video data signals Ds. The video data signal Ds is consecutively supplied with no extra signal interposed therebetween. The duration of each subfield is greatly shortened. As a result, the number of subfields is drastically increased. A driver for a high-image-quality display device thus can be obtained.

### Second Embodiment

A second embodiment of the invention is different from the first embodiment in that the timing of writing the video data signal Ds to the pixel is controlled to set the duration of each subfield at an arbitrary value. The second embodiment is implemented by the controller 40 that adjusts to any timing the output timing of the video data signal Ds to the data line driving circuit 101.

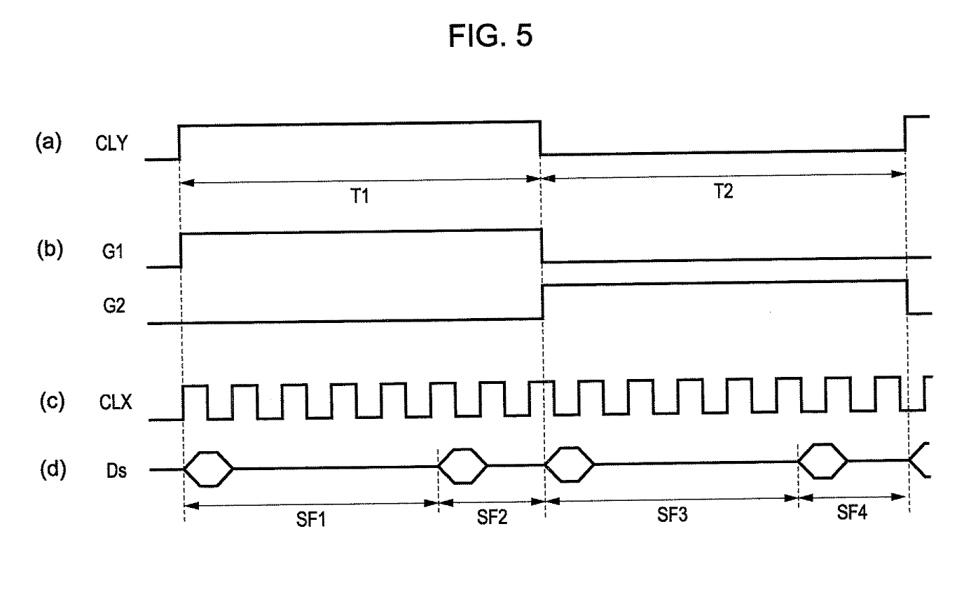

FIG. 5 is a timing diagram illustrating the scanning side transfer clock CLY, the scan signal Gn (G1 and G2 only are illustrated in FIG. 5), the data transfer clock CLX, and the video data signal Ds.

Referring to FIG. 5, the video data signal Ds is supplied twice at irregular intervals during each of the period T1 and the period T2. Any waiting time is set between two successive video data signals of a plurality of video data signals supplied to the pixels, by adjusting the supply timing of the video data signal Ds. As a result, each subfield can have any time duration. In accordance with the second embodiment, the subfield period is determined while maintaining flexibility in its duration.

### Third Embodiment

The driving method of a third embodiment of the invention is described below.

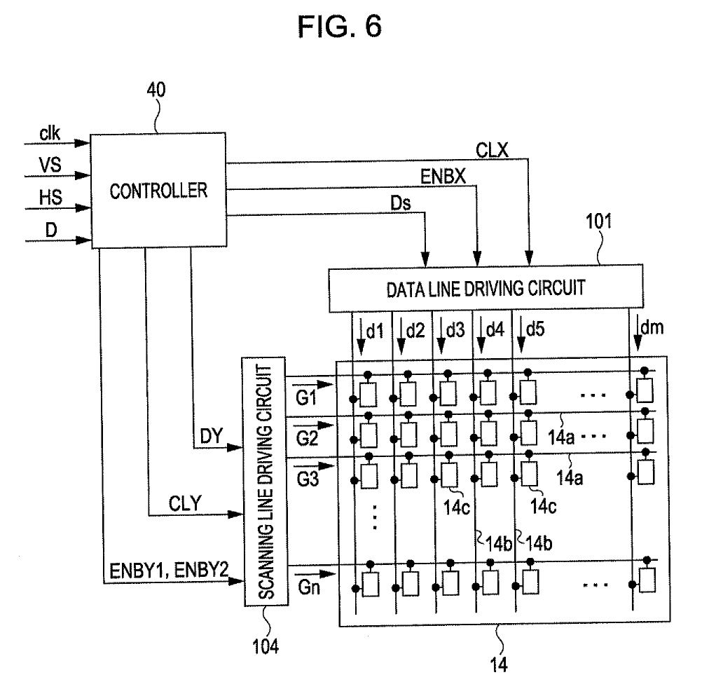

FIG. 6 is a block diagram illustrating an electrical structure of the driver in the electro-optical device in accordance with the third embodiment of the invention.

Upon receiving a clock signal, a vertical scanning signal, a horizontal scanning signal, a video signal, etc. from the outside, the controller 40 generates a start pulse DY, a scanning side transfer clock CLY, enable signals ENBY1, ENBY2, and ENBX, a data transfer clock CLX, and a video data signal Ds. The enable signals ENBY1 and ENBY2 represent one of a high level and a low level, and are used to select data to be output from the scanning line driving circuit 104 to the display panel 14. The enable signal ENBX is a pulse signal that determines the timing at which the data transfer to the scanning line driving circuit 104 starts and at which scanning line basis data is output to each pixel 14c. The enable signal ENBX is output in synchronization with a level transition (at a rising edge or a falling edge) of the scanning side transfer clock CLY. The data transfer clock CLX is a signal that defines the timing of the transfer of data to the data line driving circuit 101. The video data signal Ds is a voltage signal corresponds to the video signal D input to the controller 40, and indicates a high level or a low level to set the pixel 14c to an on state or an off state at each subfield period.

Upon receiving the start pulse DY, the scanning side transfer clock CLY, and the enable signals ENBY1 and ENBY2 from the controller 40, the scanning line driving circuit 104 successively outputs scan signals G1, G2, G3, . . . , Gn to the scanning lines 14a of the display panel 14.

Upon receiving the enable signal ENBX, the data transfer clock CLX, and the video data signal Ds from the controller 40, the data line driving circuit 101 outputs data signals d1, d2, d3, . . . , dm to data lines 14b of the display panel 14.

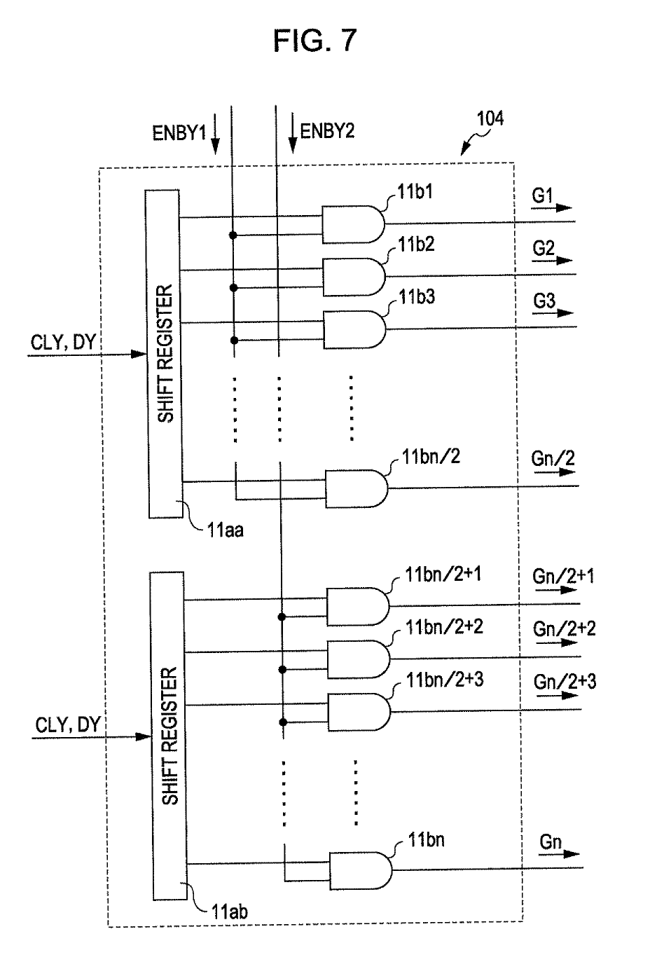

A structure and operation of the scanning line driving circuit 104 are specifically described below with reference to FIG. 7. FIG. 7 generally illustrates the structure of the scanning line driving circuit 104. The scanning line driving circuit 104 includes two shift registers 11aa and 11ab, and AND gates 11b1-11bn.

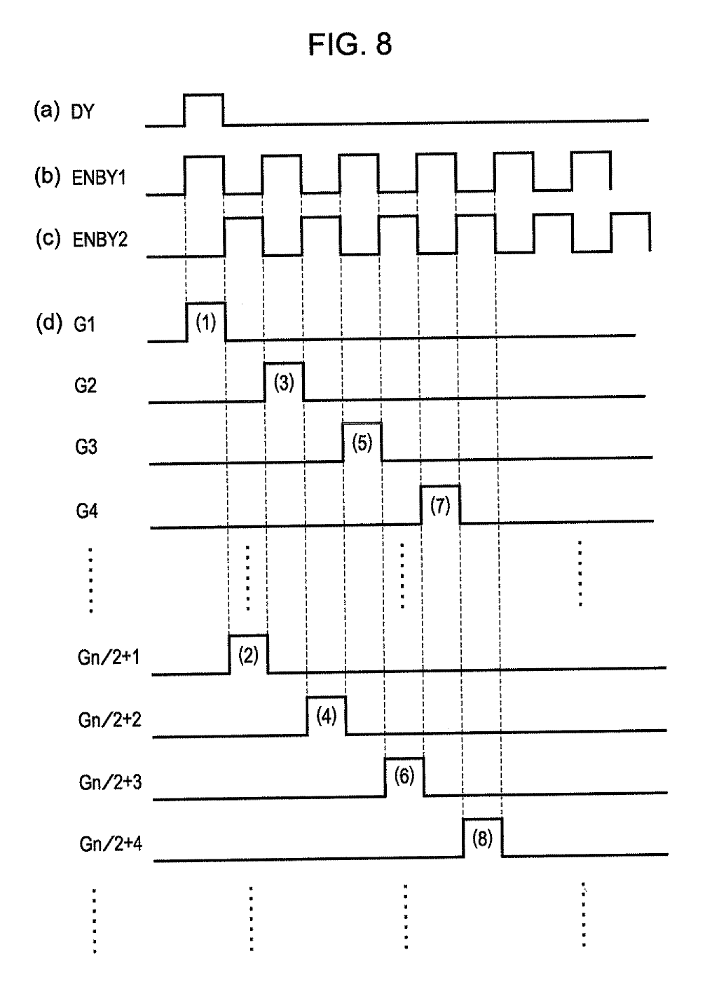

The scanning side transfer clock CLY and the start pulse DY are input to the scanning line driving circuit 104 and the enable signal ENBY1 is set to a high level. The shift register 11aa successively drives the AND gates 11b1-11bn/2 successively, thereby outputting scan signals G1-Gn/2. The scanning side transfer clock CLY and the start pulse DY are input to the scanning line driving circuit 104 and the enable signal ENBY2 is set to a high level. The shift register 11ab successively drives the AND gates 11bn/2+1-11bn successively, thereby outputting scan signals Gn/2+1-Gn. When the shift register 11aa outputs the scan signals G1-Gn/2, the upper half scanning lines of an image display region 10a is driven. When the shift register 11ab outputs the scan signals Gn/2+1-Gn, the lower half scanning lines of the image display region 10a is driven. In response to the scanning side transfer clock CLY and the start pulse DY, the two shift registers 11aa and 11ab are driven so that the scan signals G1-Gn/2 and the scan signal Gn/2+1-Gn are alternately selected. In accordance with the third embodiment of the invention, the scan signals G1-Gn are successively output in response to the scanning side transfer clock CLY and the start pulse DY in the order of G1, Gn/2+1, G2, Gn/2+2, G3, Gn/2+3, . . . , Gn/2, and Gn (see FIG. 8).

The image display region 10a is divided into two areas. In other words, the plurality of the scanning lines is divided into two groups, i.e., a first group and a second group. One of the scanning lines which belong to the first group and one of the scanning lines which belong to the second group are alternately selected. In this way, pixels connected to one scanning line perform display while the other scanning line is assigned to an address period. More specifically, the subfield period is set to be shorter than one vertical scanning period by driving alternately two scanning lines. In other words, the area scanning is performed in the subfield-driving method.

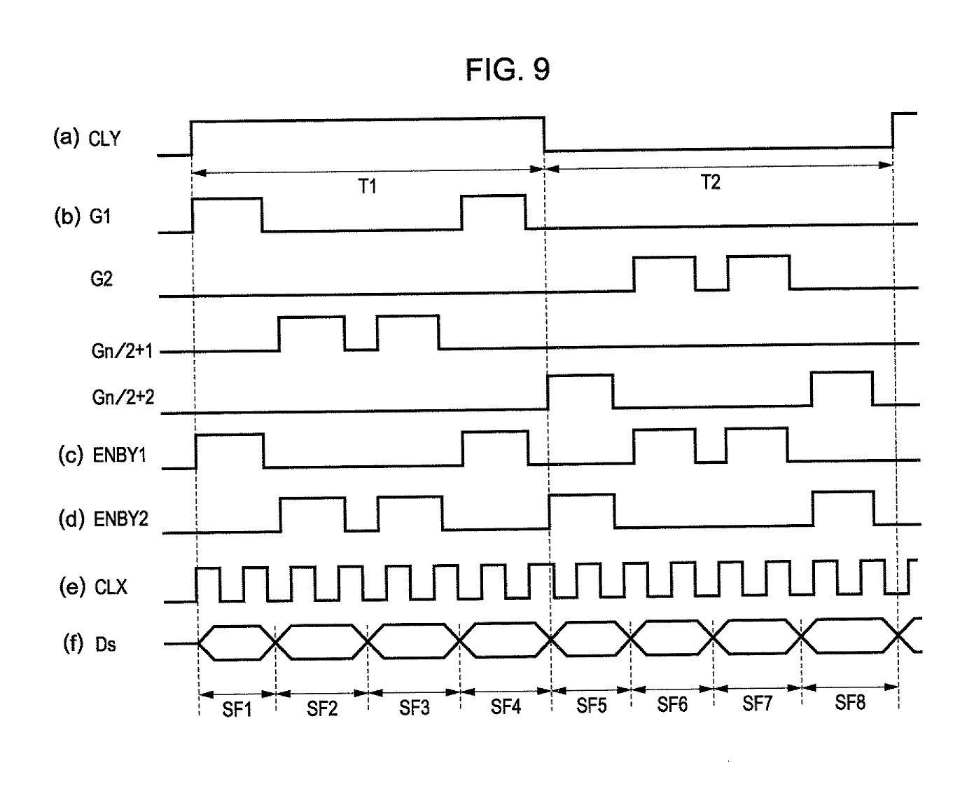

FIG. 9 is a timing diagram illustrating a scan signal Gk, the enable signals ENBY1 and ENBY2, the data transfer clock CLX and the video data signal Ds within one period of the scanning side transfer clock CLY in accordance with the third embodiment of the invention.

When the enable signal ENBY1 is set to be high during the period T1, the scan signal G1 is set to be high. When the enable signal ENBY2 is set to be high, the scan signal Gn/2+1 is set to be high. During the period T2, the scanning signals to be driven are shifted one by one. When the enable signal ENBY1 is set to be high, the scan signal is set to be high, and when the enable signal ENBY2 is set to be high, the scan signal Gn/2+2 is set to be high.

Referring to a portion (f) of FIG. 9, the enable signal ENBY1 remains at a high level during a subfield SF2, and the scanning line driving circuit 104 outputs the scan signal G1, thereby driving the pixels arranged along the selected scanning line. The video data signal Ds is then written on the pixels, thereby driving the pixels to on or off.

The enable signal ENBY2 remains at a high level during the subfield SF2. In response the enable signal ENBY2, the scanning line driving circuit 104 outputs the scan signal Gn/2+1, thereby driving the pixels along the selected scanning line. The binary data Ds is then written on the pixels along the same scanning line, thereby driving the pixels to on or off.

During the subfield SF3, as during the subfield SF2, the enable signal ENBY2 remains at a high level. In response to the enable signal ENBY2, the scanning line driving circuit 104 outputs the scan signal Gk. The binary data Ds is written on the pixels along the same scanning line, thereby driving the pixels to on or off. Since the scanning line is selected by the same enable signal ENBY2 during the subfields SF2 and SF3, the video data signal Ds is received without changing the state of the scanning line driving circuit 104.

During the subfield SF4, the enable signal ENBY1 is at a high level again. In response to the enable signal ENBY1, the scanning line driving circuit 104 outputs the scan signal G1, and the same scanning line that was selected during the subfield SF1 is also selected. The video data signal Ds is written on the pixels connected to the same scanning line, thereby driving the pixels to on or off.

During the period T2, the video data signal Ds representing one of the on voltage and the off voltage in each subfield period is input during the period T2 as illustrated in FIG. 9. The writing to the pixels is thus performed.

Concerning the first group, a scan signal, like the scan signal G1 (or scan signal Gn/2+2), is supplied to the same scanning line before and after alternating from which group one of the plurality of scanning lines is selected. Concerning the second group, a scan signal, like the scan signal G2 (or scan signal Gn/2+1) is supplied twice to the same scanning line. Thus area switching is performed. Since each of the subfields has the same duration, a plurality of subfields can be efficiently placed within one frame. By narrowing or widening an interval between the enable signal ENBY1 and the enable signal ENBY2, the length of each subfield can be adjusted in wider range.

In accordance with the third embodiment of the invention, the duration of each subfield and the number of subfields can be flexibly adjusted in comparison with the other embodiments. The number of writing the video data signals Ds determines the number of subfields. The number of subfields is thus increased in accordance with the write timing of the video data signal without increasing the scanning speed of the scanning lines. As a result, a display device operating on a line-at-a-time scanning basis can display a high-quality image using the subfield-driving method featuring a large number of gray scales.

### Electro-Optical Device

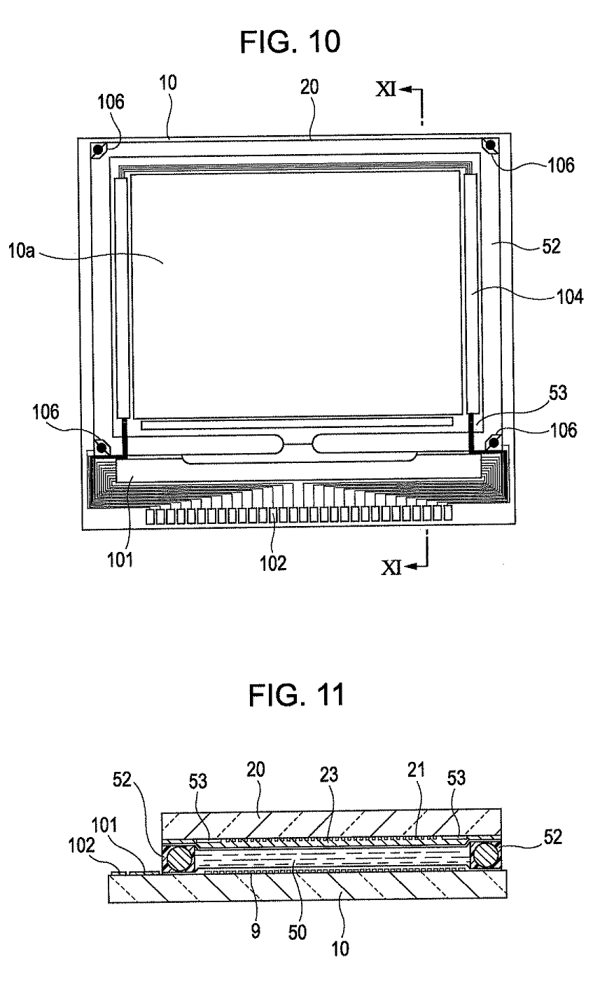

An electro-optical device 500 incorporating the above-described driver is described below with reference to FIGS. 10 and 11. In the following embodiments, the electro-optical device is an active-matrix driving thin-film transistor (TFT) liquid-crystal device.

A structure of an electro-optical panel of the electro-optical device of one embodiment of the invention is described first. FIG. 10 is a plan view of the electro-optical device of the embodiment of the invention. FIG. 11 is a sectional view of the electro-optical device taken along line VI-VI in FIG. 10.

The electro-optical device 500 includes a TFT array substrate 10 and an opposed substrate 20. The TFT array substrate 10 may be a transparent substrate such as a quartz substrate or a glass substrate, or a silicon substrate. The opposed substrate 20 is a transparent substrate such as a quartz substrate or a glass substrate. A liquid-crystal layer 50 is contained between the TFT array substrate 10 and the opposed substrate 20. The liquid-crystal layer 50 is made of a liquid crystal of one type or a mixture of a plurality of types of nematic liquid crystals. The liquid-crystal layer 50 takes a predetermined alignment state between the pair of alignment layers. The TFT array substrate 10 and the opposed substrate 20 is bonded together by a seal compound 52 arranged on a sealing area on a periphery of the image display region 10a having a plurality of image electrodes thereon.

The seal compound 52 is made of an ultraviolet curing resin or a thermosetting resin for bonding the two substrates. In a manufacturing process, the seal compound 52 is applied on the TFT array substrate 10, and then exposed to ultraviolet irradiation or subjected to heating for curing. Gap members, such as glassfiber beads or glass beads, are dispersed in the seal compound 52 to maintain the gap (substrate gap) between the TFT array substrate 10 and the opposed substrate 20 to a predetermined value.

A frame outline light-shield film 53 defining the frame outline area of the image display region 10a is arranged on the opposed substrate 20 along the internal side of the seal area having the seal compound 52 arranged thereon. Alternatively, part or whole of the frame outline light-shield film 53 may be arranged as an internal light-shield film on the TFT array substrate 10.

A data line driver circuit 101 and external circuit connection terminals 102 are arranged outside and along one side of the seal area of the seal compound 52 on a periphery area. Scanning line driving circuits 104 are arranged adjacent to and along with two sides of the seal area of the seal compound 52 and covered with the frame outline light-shield film 53. To connect the two scanning line driver circuits 104 arranged on both sides of the image display region 10a, a plurality of wirings 105, covered with the frame outline light-shield film 53, are routed along the remaining side of the seal area of the seal compound 52.

Top-bottom connecting terminals 106 are arranged on the four corner portions of the TFT array substrate 10 facing the four corners of the opposed substrate 20 in order to connect the substrates via top-bottom conductive members 107. In this way, the TFT array substrate 10 is electrically connected to the opposed substrate 20.

With reference to FIG. 10, a laminate structure is formed on the TFT array substrate 10. Pixel switching TFTs as active elements and wirings for scanning lines, and data lines are embedded in the laminate structure. FIG. 10 does not illustrate the laminate structure in detail. Pixel electrodes 9a made of an electrically conductive transparent layer such as an indium tin oxide (ITO) layer are formed as islands in a predetermined pattern on the laminate structure on a pixel by pixel basis. The top surface of the pixel electrodes 9a is covered with an alignment layer. The alignment layer is in contact with the liquid-crystal layer 50.

The pixel electrodes 9a are formed in the image display region 10a of the TFT array substrate 10 in a manner such that the pixel electrodes 9a face the opposed electrode 21. An alignment layer 16 is formed on the surface of the TFT array substrate 10 facing the liquid-crystal layer 50, i.e., on the pixel electrodes 9a. The alignment layer 16 thus covers the pixel electrodes 9a.

A light-shield film 23 is formed on the surface of the opposed substrate 20 facing the TFT array substrate 10. The light-shield film 23 has a grating structure in plan view of the opposed substrate 20. The light-shield film 23 forms a non-aperture region in the opposed substrate 20. A portion defined by the light-shield film 23 serves an aperture that allows light emitted from a lamp for a projector or backlight to pass therethrough. The light-shield film 23 may be formed in stripes, and the light-shield film 23 and a variety of elements including the data lines on the TFT array substrate 10 may define the non-aperture area.

The opposed electrode 21 made of a transparent material such as ITO is formed on the light-shield film 23 to face the pixel electrodes 9a. A color filter (not shown in FIG. 10) may be formed in an area including a portion of the aperture area and the non-aperture area on the light-shield film 23 in order to present color display on the image display region 10a. An alignment layer 22 is formed on the opposed electrode on the facing surface of the opposed substrate 20.

The TFT array substrate 10 illustrated in FIGS. 10 and 11 includes driver circuits such as the data line driver circuit 101 and the scanning line driver circuit 104. The TFT array substrate 10 further includes a sampling circuit that samples a video data signal on a video data signal line and supplies the sampled video data signal to the data lines, a pre-charge circuit that supplies to the plurality of data lines a pre-charge signal at a predetermined voltage level prior to the supplying of the video data signal, and a test circuit that tests quality or fault of the electro-optical device in the middle of the manufacturing process thereof or at the shipment thereof.

The liquid crystal forming the liquid-crystal layer 50 modulates light and presents gray scale display when an alignment and order of a set of molecules vary in response to the level of an applied voltage. In a normally white mode, a transmittance ratio of the pixel to incident light is reduced in response to a voltage applied on a per pixel basis. In a normally black mode, a transmittance ratio of the pixel to incident light is increased in response to a voltage applied on a per pixel basis. The electro-optical device generally emits light having a contrast corresponds to the video signal.

A storage capacitor 70 is connected in parallel with a liquid-crystal capacitor between the pixel electrode 9a and the opposed electrode 21 so that the held video data signal is not leaked. The storage capacitor 70 temporarily holds the voltage of the pixel electrode 9a in response to the supply of the video data signal. One electrode of the storage capacitor 70 is connected to the drain of the TFT 30 and the pixel electrode 9a while the other electrode thereof is connected to a capacitance line 300 fixed to a constant voltage so that the other electrode is maintained at the constant voltage. The storage capacitor 70 improves the hold characteristics of the voltage of the pixel electrode 9a, and thus provides display characteristic improvements, such as contrast improvement and flicker reduction.

### Electronic Apparatus

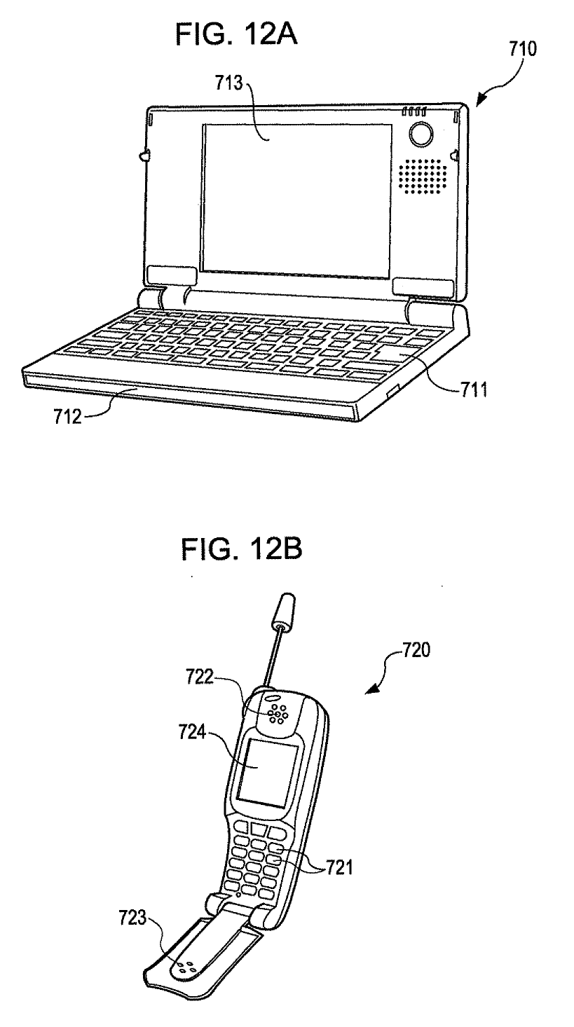

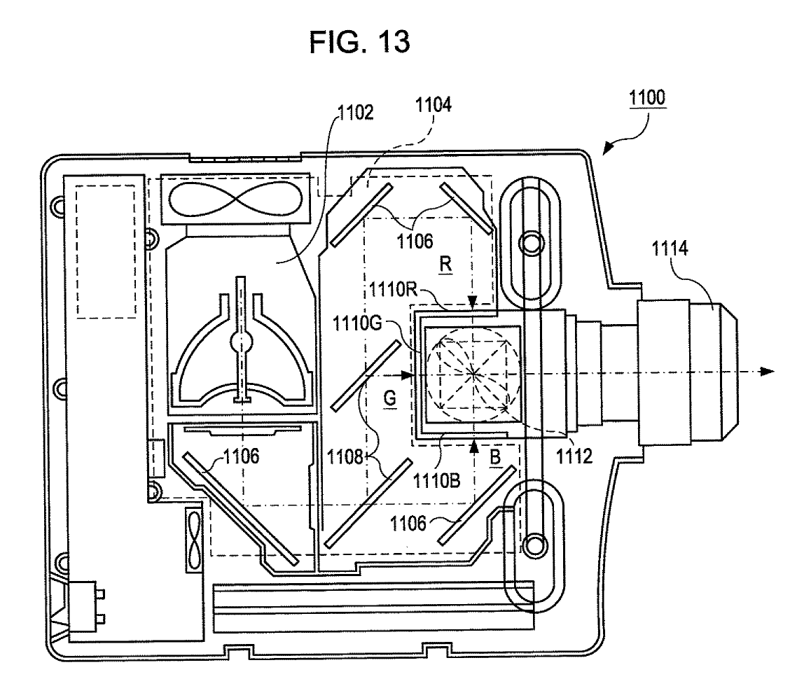

Specific examples of the electronic apparatus incorporating the electro-optical device 500 of the above-described embodiment are described with reference to FIGS. 12A and 12B and FIG. 13.

The electro-optical device 500 of the above-described embodiment is used for a display of a mobile personal computer (so-called notebook personal computer). FIG. 12A is a perspective view of a personal computer 710. The personal computer 710 includes a keyboard 711, a main unit 712, and a display 713 including a liquid-crystal display 100 of the embodiment of the invention.

The electro-optical device 500 of the above-described embodiment is used for a display of a cellular phone 720. FIG. 12B is a perspective view of the cellular phone 720. Referring to FIG. 12B, the cellular phone 720 includes a plurality of operation buttons 721, an ear piece 722, a mouthpiece 723, and a display 724 including the liquid-crystal display device of the embodiment of the invention.

With reference to FIG. 13, a projector 1100 including the electro-optical device 500 of the embodiment of the invention as a light valve is described below.

Referring to FIG. 13, the projector 1100 includes a lamp unit 1102 having a white light source such as a halogen lamp. The light beam emitted from the lamp unit 1102 is then separated into the three RGB color light rays through four mirrors 1106 and two dichroic mirrors 1108, arranged within a light guide 1104. The three RGB light rays are then respectively incident on liquid-crystal panels 1110R, 1110B, and 1110G as light valves for the RGB.

The liquid-crystal panels 1110R, 1110B, and 1110G are identical in structure to the above-described liquid-crystal device and driven by three RGB color signals supplied from a video signal processor circuit. The light rays modulated by the electro-optic panels are incident on a dichroic prism 1112 from three directions. The dichroic prism 1112 allows the R and G light rays to be refracted at right angles while causing the G light ray to travel straight. The color images are thus synthesized into a color image, which is then projected onto a screen or the like through a projection lens 1114.

As for the display images of the liquid-crystal panels 1110R, 1110B, and 1110G, the display image of the liquid-crystal panel 1110G needs to be right-left reversed in relation to the images of the liquid-crystal panels 1110R and 1110B.

Since the liquid-crystal panels 1110R, 1110B, and 1110G receive the light rays corresponds to the RGB colors via the dichroic mirrors 1108, no color filters are required.

In addition to the electronic apparatus illustrated in FIG. 13, the electro-optical device of embodiments of the invention is applicable to a variety of electronic apparatuses. Such electronic apparatuses include a mobile personal computer, a cell phone, a liquid-crystal television receiver, a view-finder type video cassette recorder, a direct-monitor-viewing type video cassette recorder, a car navigation system, a pager, an electronic notebook, a calculator, a wordprocessor, a workstation, a video phone, a point-of-sale (POS) terminal, and a touchpanel.

In addition to the liquid-crystal displays described above, the invention is applicable to a liquid crystal on silicon (LCOS) device, a plasma display (PDP), a field emission display (surface-conduction electron-emitter display (SED)), an organic electro-luminescence (EL) display, a digital micro-mirror display device (DMD), an electrophoresis device, etc.

The invention is not limited to the above-described embodiments. A variety of changes and modifications are possible to the above-described embodiments without departing from the spirit and scope of the invention. An electro-optical board and an electro-optical device incorporating such a change and modification, and an electronic apparatus including such an electro-optical device also fall within the scope of the invention.

What is claimed is:

1. A driver for subfield-driving an electro-optical device, the electro-optical device including a plurality of scanning lines, a plurality of data lines and a plurality of pixels, one of the plurality of pixels corresponding intersection where one of the plurality of scanning lines and one of the plurality of data lines intersect each other, the driver comprising:
a scan signal supplying unit that supplies the one of the scanning line with a scan signal to select the one of the scanning line; and
a video signal supplying unit that supplies the one of the data line with a plurality of video data signals, the plurality of video data signals including a first video data signal and a second video data signal,
wherein an i-th selection period in which the one of the scanning line is selected is divided into a plurality of subfields, the plurality of subfields including a first subfield and a second subfield, and
wherein the first video data signal is supplied in the first subfield, and the second video data signal is supplied in the second subfield.

2. The driver according to claim 1, wherein the first video data signal is one of an on voltage and an off voltage, and the second video data signal is the other of the on voltage and the off voltage, according to a gray scale to be displayed in the one of the plurality of pixels.

3. The driver according to claim 1, wherein the video signal supplying unit supplies the plurality of video data signals consecutively within the i-th selection period in a serial manner.

4. The driver according to claim 1, wherein the video signal supplying unit supplies the plurality of video data signals nonconsecutively within the i-th selection period in a serial manner.

5. The driver according to claim 3, wherein the video signal supplying unit supplies the plurality of video data signals at regular intervals within the i-th selection period.

6. The driver according to claim 3, wherein the video signal supplying unit supplies the plurality of video data signals at irregular or arbitrary intervals within the i-th selection period.

7. The driver according to claim 1, wherein the plurality of scanning lines is divided into a plurality of groups, the plurality of groups comprising a first group and a second group, and
wherein the one of the plurality of scanning lines is selected from the first group and the second group alternately, and
wherein the video signal supplying unit supplies the one of the plurality of date lines with the plurality of video data signals in synchronization with the scan signal.

8. The driver according to claim 7, wherein the scan signal supplying unit supplies the scan signal to the same scanning line of the plurality of scanning lines before and after alternating from which group the one of the plurality of scanning lines is selected.

9. A driver for subfield-driving an electro-optical device, the electro-optical device including a plurality of scanning lines, a plurality of data lines and a plurality of pixels, one of the plurality of pixels corresponding intersection point where one of the plurality of scanning lines and one of the plurality of data lines intersect each other, the driver comprising:
a scan signal supplying unit that supplies the one of the scanning line with a scan signal to select the one of the scanning line; and
a video signal supplying unit that supplies the one of the data line with a plurality of video data signals in synchronization with the scan signal, the plurality of video data signals including a first video data signal and a second video data signal,
wherein a frame period is divided into a plurality of subfields, the plurality of subfields including a first subfield and a second subfield, and
wherein the first video data signal is supplied in the first subfield, and the second video data signal is supplied in the second subfield, and
wherein the plurality of scanning lines is divided into a plurality of groups, the plurality of groups comprising a first group and a second group, and
wherein the one of the plurality of scanning lines is selected from the first group and the second group alternately, and
wherein the scan signal supplying unit supplies the scan signal to the same scanning line of the plurality of scanning lines before and after alternating which group the one of the plurality of scanning lines is selected from.

10. The driver according to claim 9, wherein the video signal supplying unit supplies the plurality of video data signals at regular intervals before and after alternating which group the one of the plurality of scanning lines is selected from.

11. A driving method for subfield-driving an electro-optical device, the electro-optical device including a plurality of scanning lines, a plurality of data lines and a plurality of pixels, one of the plurality of pixels corresponding intersection where one of the plurality of scanning lines and one of the plurality of data lines intersect each other, the driving method comprising:
supplying the one of the scanning line with a scan signal to select the one of the scanning line; and
supplying the one of the data line with a plurality of video data signals, the plurality of video data signals including a first video data signal and a second video data signal,
wherein an i-th selection period in which the one of the scanning line is selected is divided into a plurality of subfields, the plurality of subfields including a first subfield and a second subfield, and
wherein the first video data signal is supplied in the first subfield, and the second video data signal is supplied in the second subfield.

12. An electro-optical device comprising the driver according to claim 1.

13. An electronic apparatus comprising the electro-optical device according to claim 12.
